(19) United States
(12) Patent Application Publication
(10) Pub. No.: US 2017/0364971 A1
(43) Pub. Date: Dec. 21, 2017

(54) METHOD AND SYSTEM FOR AUTOMATIC E-MAIL ACCOUNT SETUP AND LINKAGE

(71) Applicant: MasterCard International Incorporated, Purchase, NY (US)

(72) Inventors: Garry LYONS, Dublin 14 (IE); Todd Christian LOWENBERG, Redding, CT (US); Rohit CHAUHAN, Somers, NY (US)

(73) Assignee: MasterCard International Incorporated, Purchase, NY (US)

(21) Appl. No.: 15/185,486

(22) Filed: Jun. 17, 2016

(51) Int. Cl. G06Q 30/04; G06F 17/30; H04L 12/58; H04L 29/08

(52) U.S. Cl. CPC G06Q 30/04; H04L 67/306; G06F 17/30864; H04L 51/046

(57) ABSTRACT

A method for automatic email generation and delivery based on transaction account linkage includes: storing a plurality of account profiles, each related to a transaction account and including a primary account number and an email address automatically generated for the transaction account upon issuance; receiving a transaction message for a payment transaction including a specific primary account number and transaction data; identifying a specific account profile that includes the specific primary account number; generating an email message, wherein a body of the email message includes content generated from the transaction data and a header of the email message includes the email address included in the identified specific account profile as a destination address; and transmitting the generated email message to a mail server for delivery to the destination address included in the header.

### FIELD

The present disclosure relates to automatic generation and delivery of email based on account linkage, specifically the automatic generation of an email related to a payment transaction based on data parsed from a transaction message associated therewith and delivery of the email to an automatically generated email account associated with a transaction account involved in the payment transaction.

### BACKGROUND

Often times when a consumer engages in a payment transaction with a merchant, the consumer may want to review the transaction at a later date. In the case of payment transactions funded via a transaction account, such as using a check or credit card, the consumer can review an account statement when the transaction appears, usually several days later. However, information included in account statements is often extremely limited, typically including no more than a time, date, transaction amount, and a technical name associated with the involved merchant. In the case of payment transactions funded via paper currency, there is no account statement ever available to the consumer for review.

To provide consumers and merchants both with better accounting of transactions, many merchants will furnish the consumer with a paper receipt when finalizing a payment transaction. The receipt often includes data not available in an account statement, such as detailed product information regarding purchased goods or services, service personnel information, point of sale data, loyalty data, reward data, coupon and offer data, etc. However, merchants do not always provide receipts to consumers, some receipts may be lacking in data wanted by the consumer, and paper receipts may be easy to misplace or lose, particularly when a consumer engages in a large number of transactions on a given day.

In an effort to assist consumers with organization, and to reduce the usage of paper, some merchants have begun to provide electronic receipts, or “e-receipts,” to consumers. However, the merchants often require the consumer to supply their personal email address for sending of the e-receipt. In many cases, a consumer may be unwilling to provide their personal email address, such as out of concerns for account security and to avoid the receipt of spam or unwanted communications from the merchant. In any case, it is often difficult and time consuming for the consumer to supply their email address to the merchant, as consumers must often verbally communicate their email address to an employee of the merchant that must then enter the email address into the point of sale system, which can take significant time and have a high chance of error in entry. Additionally, the storage and lack of uniformity of the e-mail formats, and need to correct them fairly frequently, leads to multiple and sometimes misdirected communications, database updates, and unnecessary network traffic and computer processing. These technical problems are hard to solve.

Thus, there is a need for a technical solution to provide for easier delivery of e-receipts to consumers that does not require the consumer to provide a personal email address directly to a merchant. There is a further need for a technical solution to provide e-receipts to consumers that does not require participation of the merchant involved in the payment transaction, to provide for easier implementation, easier standardization, and increased account security.

### SUMMARY

The present disclosure provides a description of electronic systems and automated methods for automatic email generation and delivery based on transaction account linkage, which cannot be achieved through human thought, using pen-and-paper, or through mere organization of human activity.

A method for automatic email generation and delivery based on transaction account linkage includes: storing, in an account database of a processing server, a plurality of account profiles, wherein each account profile includes a structured data set related to a transaction account including at least a primary account number and an email address; receiving, by a receiving device of the processing server, a transaction message via a payment network, wherein the transaction message is related to a payment transaction and is formatted pursuant to one or more standards and includes at least a plurality of data elements including a first data element configured to store a specific primary account number, a second data element configured to store a merchant identifier of a plurality of merchant identifiers, and one or more additional data elements configured to store transaction data; executing, by a querying module of the processing server, a query on the account database to identify a specific account profile where the primary account number corresponds to the specific primary account number stored in the first data element included in the transaction message; generating, by a generation module of the processing server, an email message, wherein a body of the email message includes at least content generated from the transaction data stored in the one or more additional data elements included in the transaction message and a header of the email message includes the email address included in the identified specific account profile as a destination address; and electronically transmitting, by a transmitting device of the processing server, the generated email message to a mail server for delivery to the destination address included in the header.

A system for automatic email generation and delivery based on transaction account linkage includes: an account database of a processing server configured to store a plurality of account profiles, wherein each account profile includes a structured data set related to a transaction account including at least a primary account number and an email address; a receiving device of the processing server configured to receive a transaction message via a payment network, wherein the transaction message is related to a payment transaction and is formatted pursuant to one or more standards and includes at least a plurality of data elements including a first data element configured to store a specific primary account number, a second data element configured to store a merchant identifier of a plurality of merchant identifiers, and one or more additional data elements configured to store transaction data; a querying module of the processing server configured to execute a query on the account database to identify a specific account profile where the primary account number corresponds to the specific primary account number stored in the first data element included in the transaction message; a generation module of the processing server configured to generate an email message, wherein a body of the email message includes at least content generated from the transaction data stored in the one or more additional data elements included in the transaction message and a header of the email message includes the email address included in the identified specific account profile as a destination address; and a transmitting device of the processing server configured to electronically transmit the generated email message to a mail server for delivery to the destination address included in the header.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the automatic generation and delivery of emails associated with a payment transaction based on data parsed therefrom in accordance with exemplary embodiments.

FIG. 2 is a block diagram illustrating the processing server of FIG. 1 for the automatic generation and delivery of an email based on payment transaction data in accordance with exemplary embodiments.

FIG. 3 is a flow diagram illustrating a process for automatic generation and delivery of an email associated with a payment transaction using the system of FIG. 1 in accordance with exemplary embodiments.

FIG. 4 is a flow diagram illustrating a process for generating, formatting, and delivering an email to an email address associated with a transaction account involved in a payment transaction using the processing server of FIG. 2 in accordance with exemplary embodiments.

FIG. 5 is a flow chart illustrating an exemplary method for automatic email generation and delivery based on transaction account linkage in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

Acquirer—An entity that may process payment card transactions on behalf of a merchant. The acquirer may be a bank or other financial institution authorized to process payment card transactions on a merchant's behalf. In many instances, the acquirer may open a line of credit with the merchant acting as a beneficiary. The acquirer may exchange funds with an issuer in instances where a consumer, which may be a beneficiary to a line of credit offered by the issuer, transacts via a payment card with a merchant that is represented by the acquirer.

Payment Rails—Infrastructure associated with a payment network used in the processing of payment transactions and the communication of transaction messages and other similar data between the payment network and other entities interconnected with the payment network. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

### System for Automatic Generation and Delivery of Emails

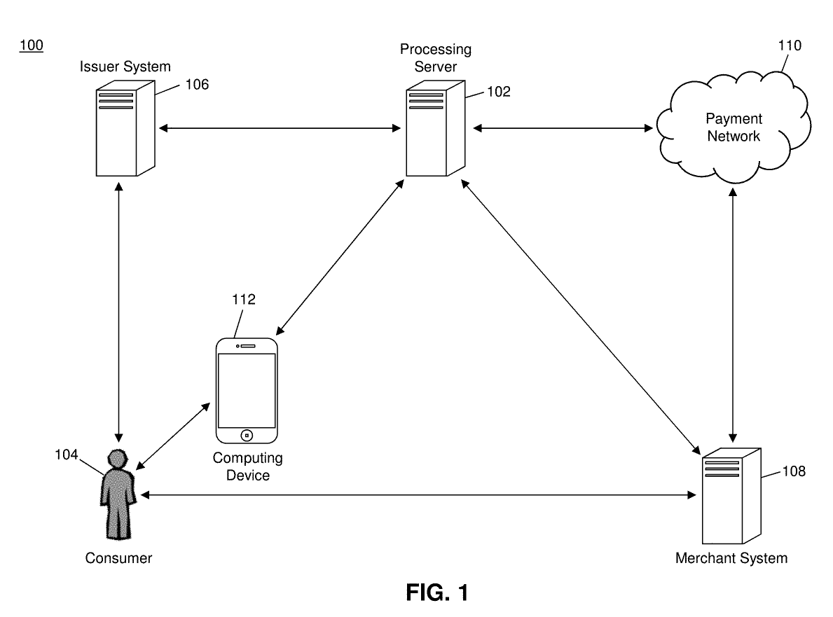

FIG. 1 illustrates a system 100 for the automatic generation and delivery of emails associated with a payment transaction including data parsed therefrom to an email address associated with a transaction account involved in the associated payment transaction.

The system 100 may include a processing server 102. The processing server 102, discussed in more detail below, may be configured to automatically generate emails based on data associated with a payment transaction and automatically deliver the email to an email address associated with a transaction account involved in the payment transaction. In the system 100, a consumer 104 may participate in a payment transaction for which the processing server 102 is configured to automatically generate and deliver an email to an email address associated with the consumer 104.

The consumer 104 may be issued a transaction account from an issuer system 106 for use in funding payment transactions. The issuer system 106 may be a computing system associated with an issuing financial institution, such as an issuing bank, which may be any entity configured to issue transaction accounts for use in funding payment transactions. As part of the issuing of the transaction account to the consumer 104, the issuer system 106 may issue one or more payment instruments to the consumer 104 for use in conveying payment details to a merchant system 108 as part of the initiation of a payment transaction. Payment instruments may include, for instance, checks, credit cards, debit cards, etc., and may be in a physical form (e.g., a paper check, plastic credit card, etc.) or may be virtual payment instruments, such as a virtual payment card.

Following, or as part of, the issuing of the transaction account to the consumer 104, the issuer system 106 may register the transaction account with the processing server 102 for the automatic generation and delivery of emails to an email address associated therewith for payment transactions involving the transaction account. The issuer system 106 may communicate with the processing server 102 via the electronic transmission and exchange of data signal superimposed or otherwise encoded with data as indicated herein, and may utilize one or more suitable communication networks and methods, which may include, for example, local area networks, wireless area networks, cellular communication networks, the Internet, payment rails, etc. In some embodiments, the processing server 102 may be a part of the issuer system 106. In such embodiments, the processing server 102 may communicate with other components and devices of the issuer system 106 using internal communication networks and protocols.

In some embodiments, the issuer system 106 may automatically generate the email address as part of the process of issuing the transaction account to the consumer 104 or as part of the process of registering the transaction account with the processing server 102. In other embodiments, the processing server 102 may automatically generate the email address as part of the process of registering the transaction account. In some instances, the email address may be an address directly related to the transaction account, such as by incorporating transaction account data in the email address. For example, the email address may include the last four numbers of the primary account number of the transaction account, may include part of the consumer's name, may include part of a username or other email address provided by the consumer 104 as part of a registration process, etc.

Once the transaction account has been registered with the processing server 102, the consumer 104 may initiate a payment transaction with a merchant via a merchant system 108 associated therewith. The merchant system 108 may be a point of sale system or other type of computing system configured to initiate and process payment transactions. As part of the initiation of the payment transaction, the consumer 104 may provide payment details associated with the transaction account to the merchant system 108, such as by using a payment instrument issued to the consumer 104 for the transaction account. The payment details may include at least the primary account number corresponding to the transaction account, and any other data that may be used in the processing of a payment transaction involving the transaction account, such as a transaction counter, one or more payment cryptograms, etc.

The merchant system 108 may receive the payment details and may submit the payment details and transaction details for the payment transaction to a payment network 110 for processing. The payment details and transaction details, collectively referred to herein as “transaction data,” may be formatted into a transaction message that is submitted to the payment network 110 via payment rails associated therewith. In some instances, the merchant system 108 may generate and submit the transaction message to the payment network 110. In other instances, the transaction message may be generated by and/or submitted by one or more intermediate entities, such as an acquiring financial institution associated with the merchant system 108 or a gateway processor.

The transaction message may be a data message used to convey transaction data that is formatted pursuant to one or more standards governing the exchange of financial transaction messages, such as the International Organization of Standardization's ISO 8583 standard. A transaction message may include a message type indicator indicative of a type of the transaction message, such as an authorization request or an authorization response. A transaction message may also include a plurality of data elements, where each data element may be configured to store data associated with a payment transaction, such as portions or all of the payment details and transaction details for the payment transaction. In some instances, a transaction message may also include one or more bitmaps, which may be configured to indicate the data elements included in the transaction message and the data stored therein.

The transaction message submitted to the payment network 110 for the payment transaction involving the consumer 104 may include a message type indicator indicative of an authorization request and may include a data element configured to store the primary account number associated with the transaction account registered with the processing server 102, a data element configured to store a merchant identifier associated with the merchant system 108, and one or more additional data elements configured to store additional transaction data. The merchant identifier may be one of a plurality of different merchant identifiers associated with merchants for whom the processing server 102 may generate emails, and may be an identification value suitable for identification of the merchant system 108 or merchant associated therewith, which may be unique to the merchant, and may include, for instance, a merchant identification number, merchant name, registration number, street address, etc. The additional transaction data may include additional payment details, such as a payment cryptogram, and transaction details, such as a transaction amount, transaction time, transaction data, geographic location, point of sale data, product data, merchant data, consumer data, loyalty data, reward data, offer data, issuer data, acquirer data, etc.

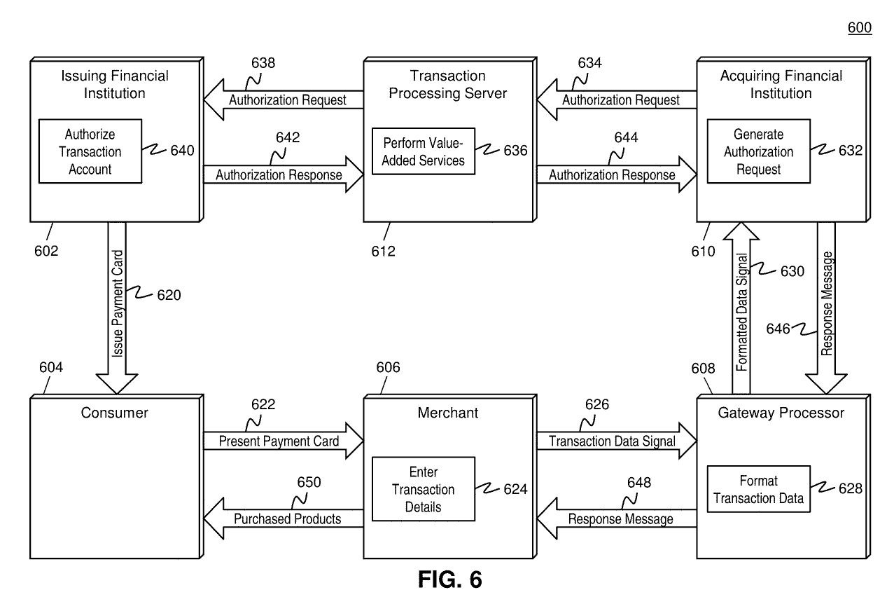

The payment network 110 may receive the transaction message via the payment rails associated therewith. The payment network 110 may then process the payment transaction using traditional methods and systems, which may include the forwarding of the transaction message to the issuer system 106 via the payment rails and receipt of an authorization response from the issuer system 106 for the payment transaction via the payment rails, which may then be forwarded back to the merchant system 108 or other associated entity via the payment rails. Additional data regarding the formatting and exchange of transaction messages and processing of payment transactions is discussed in more detail below with respect to the process 600 illustrated in FIG. 6.

During, or as a result of, the processing of the payment transaction, a transaction message for the payment transaction may be electronically transmitted to the processing server 102. In some instances, the transaction messages may be electronically transmitted to the processing server 102 via the payment rails associated with the payment network 110. In other instances, an alternative, suitable communication network may be used. In some embodiments, the processing server 102 may be a part of the payment network 110 or issuer system 106. In such embodiments, the processing server 102 may receive the transaction message from the respective entity via internal communication networks and methods. The transaction message may be an authorization request (e.g., as submitted by the merchant system 108 or associated entity) or an authorization response (e.g., as submitted by the issuer system 106 or associated entity). The transaction message may include a first data element configured to store the primary account number associated with the transaction account issued to the consumer 104, a second data element configured to store the merchant identifier associated with the merchant system 108, and one or more additional data elements included to store additional transaction data.

The processing server 102 may generate an email message for the payment transaction. The email message may include at least a body and a header. The body of the email message may include content generated based on the transaction data stored in the one or more additional data elements included in the transaction message, and may also be based on or include the merchant identifier stored in the second data element included in the transaction message. The content may include, for example, a line item listing of each product purchased by the consumer 104 as part of the payment transaction, a name of the involved merchant, a geographic location of the transaction, a transaction time and date, warranty or rebate information for purchased products, etc. The header of the email message may include the email address associated with the transaction account involved in the payment transaction as a destination address for the email message.

In some embodiments, the processing server 102 may be configured to format the body of the email message based on the merchant involved in the payment transaction, or may modify or add to the content included in the body of the email message based on the merchant. For example, the processing server 102 may include corporate identity information and data in the content, such as a company logo or company slogan, may use a font face associated with the merchant, etc. In some embodiments, the content of the body of the email message may also be based on data submitted to the processing server 102 by the merchant system 108. For example, the merchant system 108 may generate an email message for the payment transaction, which may be routed to the processing server 102 using traditional methods. The email message generated by the merchant system 108 may be, for example, an e-receipt, an email for the delivery of warranty or rebate information, etc. The processing server 102 may then use the data included therein in the generation of the body of the email message for delivery to the consumer 104.

Once the email message is generated, the processing server 102 may make the email available for viewing by the consumer 104. In some instances, making the email available may include emailing the email (e.g., via one or more mail servers) to the email address associated with the consumer 104 that is indicated as the destination address in the header of the email message. In other instances, making the email available may include storing the email message in an account associated with the email address in a mail database, such as in instances where the processing server 102 may operate a mail server.

The consumer 104 may then be able to view the email message related to their payment transaction via a computing device 112. The computing device 112 may be any suitable computing device, such as a desktop computer, laptop computer, notebook computer, tablet computer, cellular phone, smart phone, smart watch, smart television, wearable computing device, implantable computing device, etc. The consumer 104 may be provided with information used in accessing the email messages associated with the email address generated for their issued transaction account by the issuer system 106 or by the processing server 102, such as via a web page access by the consumer 104, an application program associated with the processing server 102 and/or issuer system 106 executed by the computing device 112, receipt of an email message using a personal email address used by the consumer 104 during registration of the transaction account, receipt of a short message service or other message service message by the computing device 112, or other suitable method.

The consumer 104 may access the email address automatically generated for their transaction account using the computing device 112 and then view the email message. The consumer 104 may view the body of the email message, which may include the content generated by the processing server 102 based on the data parsed from the transaction message for the payment transaction. The consumer 104 may thus be able to view e-receipts and other data for payment transactions conducted with a plurality of different merchants, without having to furnish a personal e-mail address to merchants, and without the merchants obtaining the e-mail address.

In some embodiments, the processing server 102 may include a reply address associated with the merchant involved in the payment transaction in the header of the email message. The reply address may be provided by the merchant system 108 in the transaction message or may be separately provided to the processing server 102. The reply address may be provided in the email message to the consumer 104 for use by the consumer 104 in interacting with the merchant following the payment transaction. In some such embodiments, the processing server 102 or a mail server associated therewith used to route email messages to/from the email address may be configured to forward correspondence with merchants via one or more intermediate email address, such that the merchant system 108 may not obtain the email address associated with the transaction account. In such an embodiment, spam and other unwanted correspondence may be filtered prior to delivery to the email address associated with the transaction account.

The methods and systems discussed herein enable the processing server 102 to automatically generate and deliver email messages for payment transactions that include data parsed from a transaction message associated therewith. As a result, e-receipts and other data related to payment transactions may be made available to consumers 104 for transactions involving a plurality of different merchants without requiring the consumer 104 to provide their personal email address to merchants. In addition, by generating the email message using a transaction message, email messages may be generated for transactions involving merchants that may not have merchant systems 108 capable of generating and delivering e-receipts directly, which may enable e-receipts to be provided to consumers 104 without modification to existing merchant systems. As a result, the technological improvements provided by the processing server 102 as discussed herein may enable the consumer 104 to receive email messages for payment transactions with minimal or no merchant participation and without sacrifice to consumer security and privacy.

### Processing Server

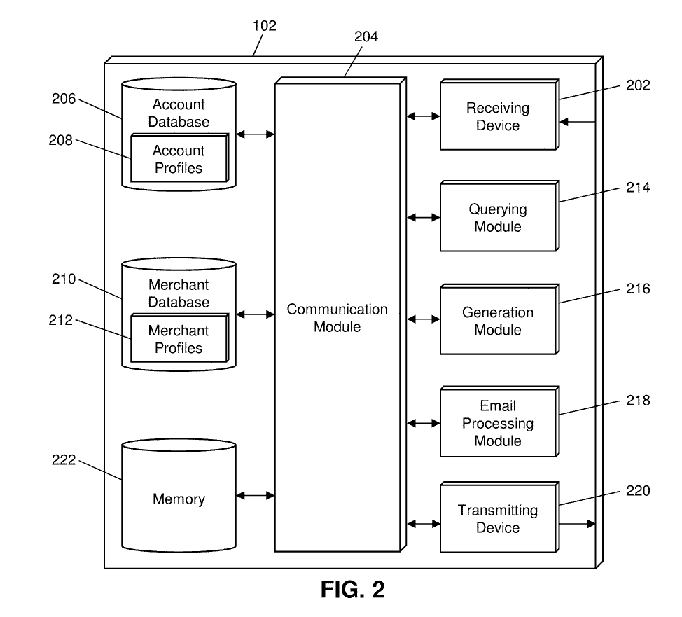

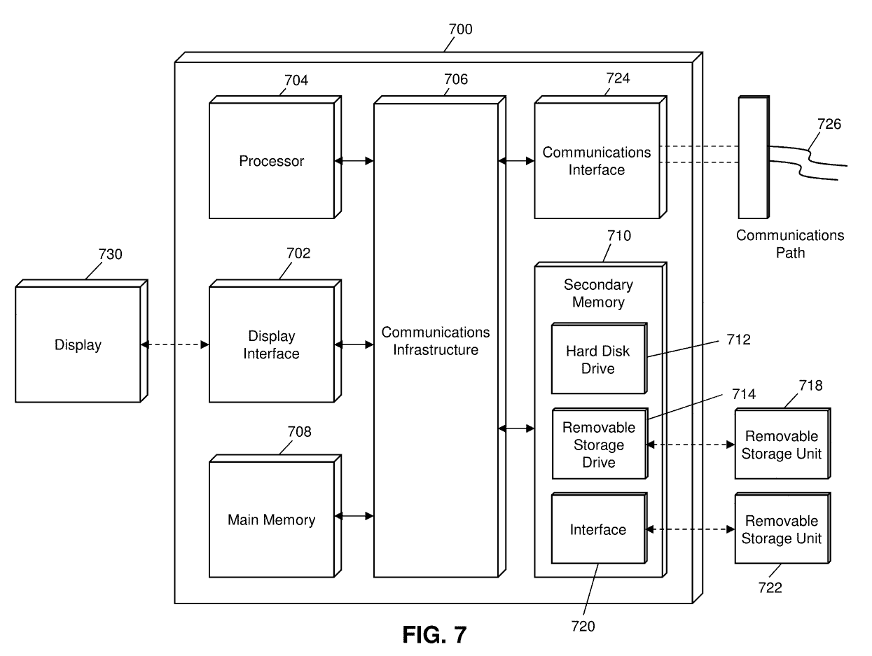

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 110 for the transmission of transaction messages that include sensitive financial data and information. In some instances, the receiving device 202 may also be configured to receive data from issuer systems 106, merchant systems 108, payment networks 110, computing devices 112, mail servers, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive data signals that are electronically transmitted, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by payment networks 104, issuer systems 106, and/or merchant systems 108 that are superimposed or otherwise encoded with transaction messages for payment transactions. Transaction messages may be formatted pursuant to one or more standards, including the ISO 8583 standard, and include a message type indicator and a plurality of data elements, including a data element configured to store a primary account number, a data element configured to store a merchant identifier, and one or more additional data elements configured to store transaction data. The receiving device 202 may also be configured to receive data signals electronically transmitted by issuer systems 106 that may be superimposed or otherwise encoded with registration data used for registration of a transaction account. The registration data may include at least a primary account number, and may also include an email address generated or otherwise identified by the issuer system 106, and communication data for communicating with the consumer 104, such as a personal email address, phone number, username, device identifier (e.g., associated with the computing device 112), etc. The receiving device 202 may also be configured to receive data signals electronically transmitted by or on behalf of the merchant system 108 that may be superimposed or otherwise encoded with email messages, which may include data associated with a payment transaction involving the merchant system 108.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 214, a generation module 216, an email processing module 218, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include an account database 206. The account database 206 may be configured to store a plurality of account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account. Each account profile 208 may include at least a primary account number and an email address. The email address may be generated by the processing server 102, as discussed below, or provided by the issuer system 106 as part of the registration of the related transaction account.

In some embodiments, the processing server 102 may also include a merchant database 210. The merchant database 210 may be configured to store a plurality of merchant profiles 212 using a suitable data storage format and schema. The merchant database 210 may be a relational database that utilizes structured query language for the storage, identification, modifying, updating, accessing, etc. of structured data sets stored therein. Each merchant profile 212 may be a structured data set configured to store data related to a merchant. Each merchant profile 212 may include a merchant identifier and additional data used by the processing server 102 in the generation of email messages for payment transactions involving the related merchant. The additional data may include, for instance, corporate identity rules or other rules regarding content included in the body of the email message, a merchant email address for use as a reply address or origination address for the email message, etc.

The processing server 102 may also include a querying module 214. The querying module 214 may be configured to execute queries on databases to identify information. The querying module 214 may receive one or more data values or query strings, and may execute a query string based thereon on an indicated database, such as the account database 206, to identify information stored therein. The querying module 214 may then output the identified information to an appropriate engine or module of the processing server 102 as necessary. The querying module 214 may, for example, execute a query on the account database 206 to identify an account profile 208 related to an authorization request for a payment transaction received from the merchant system 108, payment network 110, or issuer system 106, using the primary account number stored in a corresponding data element included therein. The querying module 214 may also be configured to execute queries on the merchant database 210 to identify a merchant profile 212 related to a merchant involved in a payment transaction, using the merchant identifier stored in a corresponding data element included therein.

The processing server 102 may also include a generation module 216. The generation module 216 may be configured to receive instructions for the generation of data and data for use therewith, may generate data as instructed, and may output the generated data to another module or engine of the processing server 102. The generation module 216 may be configured to generate email messages for payment transactions. The email messages may include a body that includes content generated from transaction data parsed from transaction messages received by the receiving device 202, and, if applicable, may format the content or add to the content based on rules and data stored in a merchant profile 212 related to a merchant involved in the payment transaction, such as may be identified via the querying module 214. Email messages generated by the generation module 216 may also include a header, which may include an email address included in an account profile 208 identified for the payment transaction (e.g., via the querying module 214) as a destination address. The generation module 216 may also be configured to generate new account profiles 208 for registration of new transaction accounts and, in some embodiments, may be configured to automatically generate a new email address for a transaction account being registered, such as in instances where an email address is not supplied by the issuer system 106.

The processing server 102 may also include an email processing module 218. The email processing module 218 may be configured to perform functions related to the receipt, delivery, storage, formatting, and display of email messages. Functions performed by the email processing module 218 will be apparent to persons having skill in the relevant art and may include the routing of email messages via one or more mail servers for delivery of an email message to a destination email address, the formatting of an email message for display to a consumer 104 via a computing device 112, the forwarding of an email message via one or more email addresses, etc.

The processing server 102 may also include a transmitting device 220. The transmitting device 220 may be configured to transmit data over one or more networks via one or more network protocols. In some embodiments, the transmitting device 220 may be configured to transmit data over the payment rails, such as using specially configured infrastructure associated with payment networks 110 for the transmission of transaction messages that include sensitive financial data and information, such as identified payment credentials. In some instances, the transmitting device 220 may be configured to transmit data to issuer systems 106, merchant systems 108, payment networks 110, computing devices 112, mail servers, and other entities via alternative networks, such as the Internet. In some embodiments, the transmitting device 220 may be comprised of multiple devices, such as different transmitting devices for transmitting data over different networks, such as a first transmitting device for transmitting data over the payment rails and a second transmitting device for transmitting data over the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to issuer systems 106 that may be superimposed or otherwise encoded with data associated with the registration of a transaction account, such as a generated email address and/or data suitable for the access thereof for forwarding to a consumer 104. The transmitting device 220 may also be configured to electronically transmit data signals superimposed or otherwise encoded with generated email messages to email servers and/or to the email processing module 218 for delivery thereto. In some instances, the transmitting device 220 may be configured to electronically transmit data signals to computing devices 112 based on communication data received during registration of a transaction account, where the data signals may be superimposed or otherwise encoded with data used for accessing email messages associated with an email account, and, in some cases, the accessed email messages.

The processing server 102 may also include a memory 222. The memory 222220 may be configured to store data for use by the processing server 102 in performing the functions discussed herein. The memory 222 may be configured to store data using suitable data formatting methods and schema and may be any suitable type of memory, such as read-only memory, random access memory, etc. The memory 222 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art.

### Automated Delivery of an Email Message for a Payment Transaction

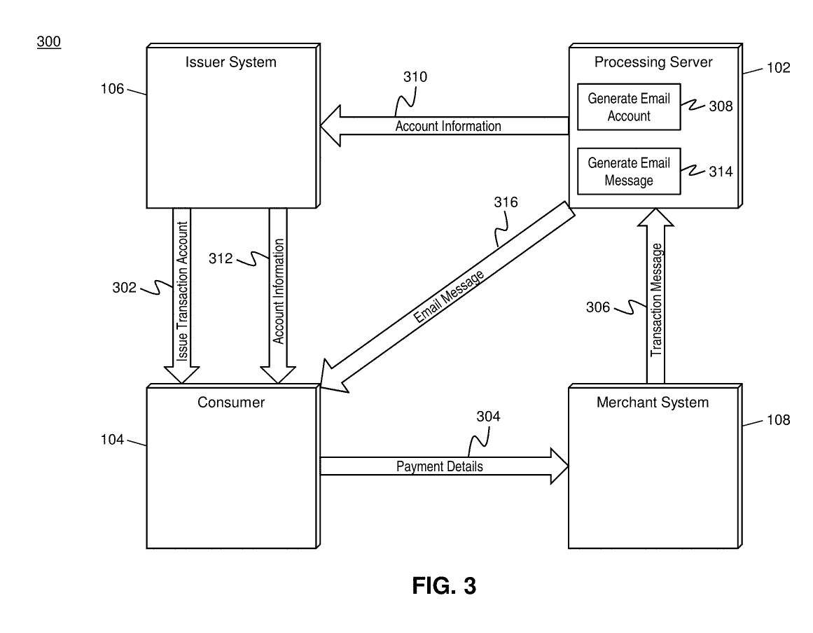

FIG. 3 illustrates a process 300 for the automated generation and delivery of an email message for a payment transaction to a transaction account involved therewith via a linkage of the transaction account to an email address.

In step 302, the issuer system 106 may issue a transaction account to the consumer 104. The issuing of the transaction account may include the generation or identification of a primary account number for corresponding to the transaction account and the issuing of a payment instrument to the consumer 104 for use in conducting payment transactions to be funded via the issued transaction account. The consumer 104 may receive the payment instrument and, in step 304, may present the payment instrument to the merchant system 108 as part of the initiation of a payment transaction with the merchant system 108. The merchant system 108 may read or otherwise receive payment details from the payment instrument, which may include at least the primary account number corresponding to the transaction account associated with the payment instrument.

In step 306, the merchant system 108 (e.g., or an entity associated with the merchant system 108, such as an acquiring financial institution) may generate and submit a transaction message for the payment transaction to the processing server 102. In some instances, the transaction message may be submitted to another entity, such as the payment network 110, and forward to the processing server 102 thereby. The transaction message may be electronically transmitted to the processing server 102 via the payment rails associated with the payment network 110, or another communication network suitable for the conveyance of transaction messages. The transaction message may be formatted pursuant to one or more standards, such as the ISO 8583 standard, and include a plurality of data elements including a first data element configured to store the primary account number, a second data element configured to store a merchant identifier, and one or more additional data elements configured to store additional transaction data.

In step 308, the generation module 216 of the processing server 102 may generate a new account profile 208 for the transaction account used in the payment transaction, which may include the generation of a new email address and corresponding email account. In instances, the generation module 216 may generate the new account profile 208 upon the execution of a query by the querying module 214 to identify that no existing account profile 208 in the account database 206 of the processing server 102 includes a primary account number corresponding to the primary account number stored in the corresponding data element included in the transaction message received by the processing server 102 (e.g., via the receiving device 202).

In step 310, the transmitting device 220 of the processing server 102 may electronically transmit a data signal superimposed or otherwise encoded with the generated email address and other email account information to the issuer system 106. The other email account information may include information suitable for the accessing of the email account, such as a username and/or password, a uniform resource locator, etc. In step 312, the issuer system 106 may forward the account information 312 to the consumer 104, such as via the computing device 112 associated with the consumer 104.

In step 314, the generation module 216 of the processing server 102 may generate an email message for the payment transaction. The email message may include at least a body and a header. The body may include content generated by the generation module 216 based at least on the transaction data stored in the data elements included in the received transaction message. In some instances, the content may be added to or formatted based on data and/or rules stored in a merchant profile 212 associated with the merchant system 108 involved in the payment transaction, such as may be identified by the querying module 214 via the merchant identifier stored in the transaction message. The header of the email message may include at least the newly generated email address as a destination address. In some instances, the header may also include a merchant address as a source address and/or reply address, as may be identified from the merchant profile 212 identified for the payment transaction.

In step 316, the transmitting device 220 and/or email processing module 218 of the processing server 102 may electronically transmit a data signal superimposed or otherwise encoded with the generated email message to the generated email address for access by the consumer 104. The consumer 104 may, via the computing device 112, access the generated email address using the account information forwarded by the issuer system 106 and view the email message generated for the payment transaction. The email message may be an e-receipt for the payment transaction, may include warranty or rebate information, or any other data based on the transaction data parsed from the transaction message. In some embodiments, the consumer 104 may be able to customize email messages generated for payment transactions, such as by providing one or more preferences to the processing server 102 (e.g., via the computing device 112), which may be stored in the corresponding account profile 208 and used during the subsequent generation of email messages.

### Automatic Generation of Email Messages Based on Transaction Data

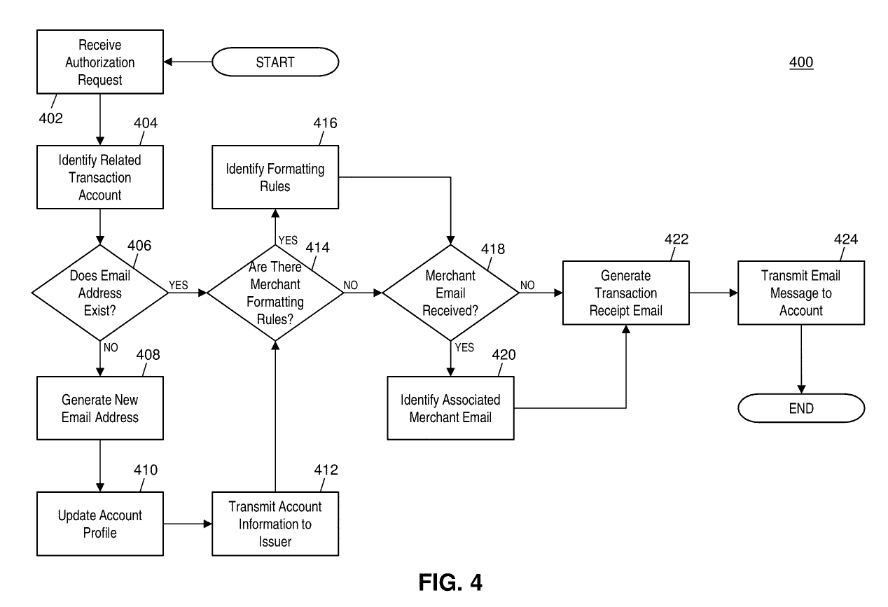

FIG. 4 illustrates a process 400 executed by the processing server 102 for the automatic generation and delivery of email messages for a payment transaction based on transaction data associated therewith.

In step 402, the receiving device 202 of the processing server 102 may receive an authorization request for a payment transaction. The authorization request may be a transaction message that includes a message type indicator indicative of an authorization request and a plurality of data elements including a data element configured to store a primary account number, a data element configured to store a merchant identifier, and one or more data elements configured to store additional transaction data. The merchant identifier may be a merchant identifier associated with one of a plurality of different merchants. The authorization request may be received from the payment network 110, merchant system 108, or issuer system 106, and may be received via the payment rails associated with the payment network 110.

In step 404, the querying module 214 of the processing server 102 may execute a query on the account database 206 to identify an account profile 208 related to the transaction account used in the payment transaction by identifying an account profile 208 where the included primary account number corresponds to the primary account number stored in the corresponding data element included in the received authorization request. In step 404, the processing server 102 may determine if an email address exists for the transaction account involved in the payment transaction. The determination may be based on the inclusion of an email address in the identified account profile 208.

If it is determined that no email address exists for the transaction account, then, in step 408, the generation module 216 of the processing server 102 may generate a new email address for the transaction account. In some instances, the email address may be a random or pseudo-random address. In other instances, the email address may be based on or include data related to the transaction account. In step 410, the querying module 214 of the processing server 102 may execute a query on the account database 206 to update the account profile 208 to include the newly generated email address. In step 412, the transmitting device 220 of the processing server 102 may electronically transmit a data signal to the issuer system 106 associated with the transaction account (e.g., such as may be identified via data included in the account profile 208 or the transaction message) that is superimposed or otherwise encoded with email account information, including at least the generated email address.

Once the email address is generated, or if the email address related to the transaction account already existed as determined in step 406, then, in step 414, the processing server 102 may determine if merchant formatting rules exist for the merchant involved in the payment transaction. The determination may be based on the execution of a query by the querying module 214 on the merchant database 210 to identify if a merchant profile 212 exists that includes a merchant identifier corresponding to the merchant identifier stored in the corresponding data element included in the received authorization request. If no merchant profile 212 exists, the process 400 may proceed. If a merchant profile 212 does exist, then, in step 416, the querying module 214 may identify formatting rules included therein for use in formatting an email message.

In step 418, the processing server 102 may determine if an email message for the payment transaction has been received from the merchant involved in the payment transaction. The determination may be based on the receipt of any email messages that indicate the merchant involved in the payment transaction as an originator or otherwise involved with the sending of the email message, such as may be identified via the merchant identifier or other data stored in the received authorization request, or the merchant profile 212, if applicable. If an email message was received from the merchant, then, in step 420, the querying module 214 or email processing module 218 of the processing server 102 may identify the merchant email message associated with the payment transaction.

In step 422, the generation module 216 of the processing server 102 may generate an email message for the payment transaction. The generated email message may include a body and a header. The body may include content generated based on the transaction data stored in the data elements included in the received authorization request, which may also be based on data stored in a merchant profile 212 identified for the payment transaction, if applicable, data included in an email message provided by the merchant for the payment transaction, if applicable, and may be formatted pursuant to any identified formatting rules, if applicable. The header may include the email address stored in the account profile 208 (e.g., generated by the generation module 216) as a destination address, and may, if applicable, include an address associated with the merchant (e.g., included in the identified merchant profile 212) as a reply address and/or sending address. In step 424, the transmitting device 220 and/or email processing module 218 of the processing server 102 may deliver the email message to the email account associated with the transaction account via the email address.

### Exemplary Method for Automatic Email Generation and Delivery Based on Transaction Account Linkage

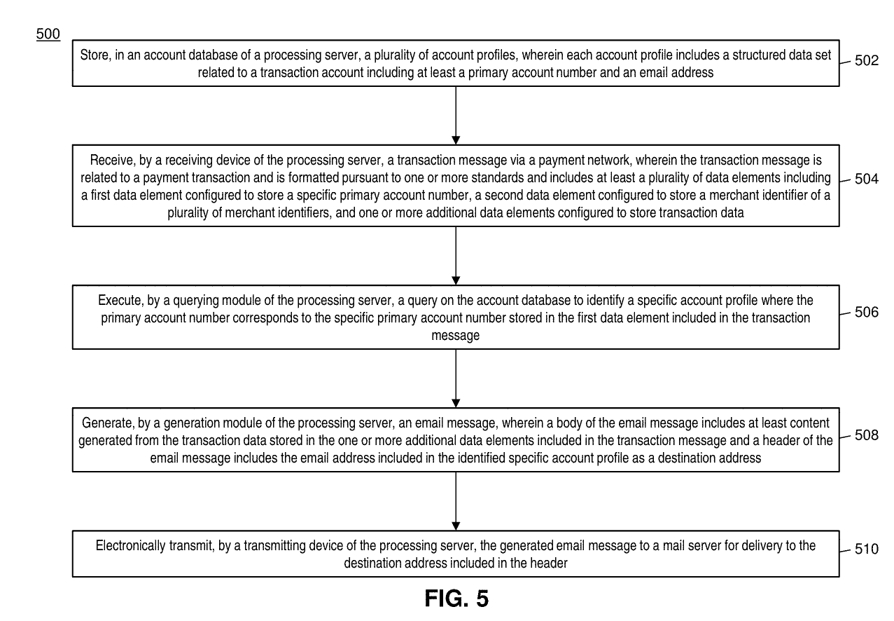

FIG. 5 illustrates a method 500 for the automatic generation and delivery of an email message related to a payment transaction based on a linkage of a transaction account involved in the related payment transaction to an email address.

In step 502, a plurality of account profiles (e.g., account profiles 208) may be stored in an account database (e.g., the account database 206) of a processing server (e.g., the processing server 102), wherein each account profile includes a structured data set related to a transaction account including at least a primary account number and an email address. In step 504, a transaction message may be received by a receiving device (e.g., the receiving device 202) of the processing server via a payment network (e.g., the payment network 110), wherein the transaction message is related to a payment transaction and is formatted pursuant to one or more standards and includes at least a plurality of data elements including a first data element configured to store a specific primary account number, a second data element configured to store a merchant identifier of a plurality of merchant identifiers, and one or more additional data elements configured to store transaction data.

In step 506, a query may be executed on the account database by a querying module (e.g., the querying module 214) to identify a specific account profile where the primary account number corresponds to the specific primary account number stored in the first data element included in the transaction message. In step 508, an email message may be generated by a generation module (e.g., the generation module 216) of the processing server, wherein a body of the email message includes at least content generated from the transaction data stored in the one or more additional data elements included in the transaction message and a header of the email message includes the email address included in the identified specific account profile as a destination address.

In step 510, the generated email message may be electronically transmitted by a transmitting device (e.g., the transmitting device 220) of the processing server to a mail server for delivery to the destination address included in the header. In some embodiments, the method 500 may also include receiving, by the receiving device of the processing server, a preliminary email message, wherein the preliminary email message includes a body including data associated with the related payment transaction, wherein the body of the generated email message further includes at least a portion of the data associated with the related payment transaction included in the body of the preliminary email message.

In one embodiment, the method 500 may further include: storing, in a merchant database (e.g., the merchant database 210) of the processing server, a plurality of merchant profiles (e.g., merchant profiles 212), wherein each merchant profile includes a structured data set associated with a merchant and includes at least a merchant identifier and one or more rules for formatting the body of the email message; and executing, by the querying module of the processing server, a query on the merchant database to identify a specific merchant profile where the merchant identifier corresponds to the merchant identifier stored in the second data element included in the transaction message, wherein the body of the email message is formatted pursuant to the one or more rules included in the identified specific merchant profile. In a further embodiment, the one or more rules for formatting the body of the email message may include at least one of: rules for displaying a logo, rules for displaying a slogan, and corporate identity rules.

In some embodiments, if the specific primary account number does not correspond to a primary account number included in an account profile stored in the account database of the processing server, the method 500 may further include generating, by the generation module of the processing server, a new account profile, wherein the new account profile is related to a transaction account involved in the related payment transaction and includes at least the specific primary account number and a new email address, wherein the specific account profile is the generated new account profile. In a further embodiment, the method 500 may even further include generating, by the generation module of the processing server, the new email address. In another further embodiment, the method 500 may also include receiving, the receiving device of the processing server, the new email address from a financial institution associated with the transaction account involved in the related payment transaction.

In one embodiment, the header of the email message may include a merchant email address associated with a merchant of a plurality of merchants involved in the related payment transaction as a reply address. In a further embodiment, the merchant email address may be included in the transaction data stored in the one or more additional data elements included in the transaction message. In another further embodiment, the method 500 may also include: storing, in the merchant database of the processing server, a plurality of merchant profiles, wherein each merchant profile includes a structured data set associated with a merchant and includes at least a merchant identifier and a merchant address; and executing, by the querying module of the processing server, a query on the merchant database to identify a specific merchant profile where the merchant identifier corresponds to the merchant identifier stored in the second data element included in the transaction message, wherein the merchant email address included in the header of the email message is the merchant address included in the identified specific merchant profile.

### Payment Transaction Processing System and Process

FIG. 6 illustrates a transaction processing system and a process 600 for the processing of payment transactions in the system. The process 600 and steps included therein may be performed by one or more components of the system 100 discussed above, such as the processing server 102, consumer 104, issuer system 106, merchant system 108, payment network 110, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3-5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 660, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc., that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for automatic email generation and delivery based on transaction account linkage. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for automatic email generation and delivery based on transaction account linkage, comprising:
storing, in an account database of a processing server, a plurality of account profiles, wherein each account profile includes a structured data set related to a transaction account including at least a primary account number and an email address;
receiving, by a receiving device of the processing server, a transaction message via a payment network, wherein the transaction message is related to a payment transaction and is formatted pursuant to one or more standards and includes at least a plurality of data elements including a first data element configured to store a specific primary account number, a second data element configured to store a merchant identifier of a plurality of merchant identifiers, and one or more additional data elements configured to store transaction data;
executing, by a querying module of the processing server, a query on the account database to identify a specific account profile where the primary account number corresponds to the specific primary account number stored in the first data element included in the transaction message;
generating, by a generation module of the processing server, an email message, wherein a body of the email message includes at least content generated from the transaction data stored in the one or more additional data elements included in the transaction message and a header of the email message includes the email address included in the identified specific account profile as a destination address; and
electronically transmitting, by a transmitting device of the processing server, the generated email message to a mail server for delivery to the destination address included in the header.

2. The method of claim 1, further comprising:
storing, in a merchant database of the processing server, a plurality of merchant profiles, wherein each merchant profile includes a structured data set associated with a merchant and includes at least a merchant identifier and one or more rules for formatting the body of the email message; and
executing, by the querying module of the processing server, a query on the merchant database to identify a specific merchant profile where the merchant identifier corresponds to the merchant identifier stored in the second data element included in the transaction message, wherein
the body of the email message is formatted pursuant to the one or more rules included in the identified specific merchant profile.

3. The method of claim 2, wherein the one or more rules for formatting the body of the email message includes at least one of: rules for displaying a logo, rules for displaying a slogan, and corporate identity rules.

4. The method of claim 1, further comprising:
receiving, by the receiving device of the processing server, a preliminary email message, wherein the preliminary email message includes a body including data associated with the related payment transaction, wherein
the body of the generated email message further includes at least a portion of the data associated with the related payment transaction included in the body of the preliminary email message.

5. The method of claim 1, wherein if the specific primary account number does not correspond to a primary account number included in an account profile stored in the account database of the processing server, the method further comprises:
generating, by the generation module of the processing server, a new account profile, wherein the new account profile is related to a transaction account involved in the related payment transaction and includes at least the specific primary account number and a new email address, wherein
the specific account profile is the generated new account profile.

6. The method of claim 5, further comprising:
generating, by the generation module of the processing server, the new email address.

7. The method of claim 5, further comprising:
receiving, the receiving device of the processing server, the new email address from a financial institution associated with the transaction account involved in the related payment transaction.

8. The method of claim 1, wherein the header of the email message includes a merchant email address associated with a merchant of a plurality of merchants involved in the related payment transaction as a reply address.

9. The method of claim 8, wherein the merchant email address is included in the transaction data stored in the one or more additional data elements included in the transaction message.

10. The method of claim 8, further comprising:
storing, in a merchant database of the processing server, a plurality of merchant profiles, wherein each merchant profile includes a structured data set associated with a merchant and includes at least a merchant identifier and a merchant address; and
executing, by the querying module of the processing server, a query on the merchant database to identify a specific merchant profile where the merchant identifier corresponds to the merchant identifier stored in the second data element included in the transaction message, wherein
the merchant email address included in the header of the email message is the merchant address included in the identified specific merchant profile.

11. A system for automatic email generation and delivery based on transaction account linkage, comprising:
an account database of a processing server configured to store a plurality of account profiles, wherein each account profile includes a structured data set related to a transaction account including at least a primary account number and an email address;
a receiving device of the processing server configured to receive a transaction message via a payment network, wherein the transaction message is related to a payment transaction and is formatted pursuant to one or more standards and includes at least a plurality of data elements including a first data element configured to store a specific primary account number, a second data element configured to store a merchant identifier of a plurality of merchant identifiers, and one or more additional data elements configured to store transaction data;
a querying module of the processing server configured to execute a query on the account database to identify a specific account profile where the primary account number corresponds to the specific primary account number stored in the first data element included in the transaction message;
a generation module of the processing server configured to generate an email message, wherein a body of the email message includes at least content generated from the transaction data stored in the one or more additional data elements included in the transaction message and a header of the email message includes the email address included in the identified specific account profile as a destination address; and
a transmitting device of the processing server configured to electronically transmit the generated email message to a mail server for delivery to the destination address included in the header.

12. The system of claim 11, further comprising:
a merchant database of the processing server configured to store a plurality of merchant profiles, wherein each merchant profile includes a structured data set associated with a merchant and includes at least a merchant identifier and one or more rules for formatting the body of the email message, wherein
the querying module of the processing server is further configured to execute a query on the merchant database to identify a specific merchant profile where the merchant identifier corresponds to the merchant identifier stored in the second data element included in the transaction message, and
the body of the email message is formatted pursuant to the one or more rules included in the identified specific merchant profile.

13. The system of claim 12, wherein the one or more rules for formatting the body of the email message includes at least one of: rules for displaying a logo, rules for displaying a slogan, and corporate identity rules.

14. The system of claim 11, wherein
the receiving device of the processing server is further configured to receive a preliminary email message, wherein the preliminary email message includes a body including data associated with the related payment transaction, and
the body of the generated email message further includes at least a portion of the data associated with the related payment transaction included in the body of the preliminary email message.

15. The system of claim 11, wherein, if the specific primary account number does not correspond to a primary account number included in an account profile stored in the account database of the processing server,
the generation module of the processing server is further configured to generate a new account profile, wherein the new account profile is related to a transaction account involved in the related payment transaction and includes at least the specific primary account number and a new email address, and
the specific account profile is the generated new account profile.

16. The system of claim 15, wherein the generation module of the processing server is further configured to generate the new email address.

17. The system of claim 15, wherein the receiving device of the processing server is further configured to receive the new email address from a financial institution associated with the transaction account involved in the related payment transaction.

18. The system of claim 11, wherein the header of the email message includes a merchant email address associated with a merchant involved in the related payment transaction as a reply address.

19. The system of claim 18, wherein the merchant email address is included in the transaction data stored in the one or more additional data elements included in the transaction message.

20. The system of claim 18, further comprising:
a merchant database of the processing server configured to store a plurality of merchant profiles, wherein each merchant profile includes a structured data set associated with a merchant and includes at least a merchant identifier and a merchant address, wherein
the querying module of the processing server is further configured to execute a query on the merchant database to identify a specific merchant profile where the merchant identifier corresponds to the merchant identifier stored in the second data element included in the transaction message, and
the merchant email address included in the header of the email message is the merchant address included in the identified specific merchant profile.
